(19) United States
(12) Patent Application Publication
(10) Pub. No.: US 2006/0270762 A1
(43) Pub. Date: Nov. 30, 2006

(54) Cellulosic inorganic-filled plastic composite

(75) Inventor: Oscar French Noel III, Aurora, CO (US)

Correspondence Address: SHERIDAN ROSS PC, 1560 BROADWAY, SUITE 1200, DENVER, CO, 80202, US

(73) Assignee: Luzenac America, Inc., Centennial, CO (US)

(21) Appl. No.: 11/384,202

(22) Filed: Mar. 17, 2006

Related U.S. Application Data
(60) Provisional application No. 60/663,318, filed on Mar. 17, 2005.

(51) Int. Cl. C08L 1/00

(52) U.S. Cl. 524/35; 524/451

(57) ABSTRACT

The present invention is a plastic composite reinforced by cellulosic material and talc. The composite preferably includes about 20% to 40% by weight of talc, about 10% to 60% by weight of a cellulosic material, and about 20% to 70% by weight of thermoplastic polymer, wherein the total amount of talc and cellulosic material comprise about 30% to 80% by weight of the composite. The present invention also includes articles made with composites of the present invention and methods for extruding such a composite.

### REFERENCE TO RELATED APPLICATION

The present application claims priority under 35 U.S.C. §119(e) of U.S. provisional patent application No. 60/663,318 filed Mar. 17, 2005 which is incorporated herein by reference in its entirety.

### FIELD OF THE INVENTION

The invention relates to composites and extruded composites, comprising cellulosic material, a plastic polymer, and talc. Such compositions may be used for construction materials. Additionally, the invention relates to methods for forming such composites.

### BACKGROUND

This application relates to cellulosic inorganic-filled plastic composites used as a replacement for wood or wood composites in construction. Such materials are used in applications such as residential outdoor decking, marine docks, and fencing. Use of plastic or polymeric materials confers a number of advantages to construction materials. For example, polymeric materials are convenient to manufacture by both molding and extrusion processes. Additionally, they are not readily biodegradable, so materials formed from them can have a much longer effective lifespan than comparable natural materials. Accordingly, materials formed with polymers can extend the life of the structure and significantly reduce the cost of maintenance compared to materials formed with natural materials.

Inclusion of natural cellulosic materials, such as wood fiber, wood flour, sawdust, rice hulls, peanut shells, and the like, into polymeric plastic molded articles can confer a number of advantages to the final product. Natural cellulosic materials such as the ones named are waste products and therefore are low in cost, contributing to lower costs for the composite. They may also lend wood-like properties to the composite including such properties as reduced coefficient of expansion, and improved mechanical properties.

Various blends of natural fibers, pigments, and thermoplastics have been used to produce wood-plastic composites using both single and twin-screw extrusion. These products exhibit adequate mechanical properties for non-load bearing applications such as residential decking. Their properties are dependent upon weight percent of cellulosic material, type of cellulosic material, type of thermoplastic, and type and weight percentage of lubricant.

A major limitation of composites which incorporate cellulosic fillers is their moisture sensitivity. This sensitivity is exhibited in use by water absorption resulting in weight gain, thickness swell, and even warpage. These cause problems with durability and performance in service. Another problem associated with cellulosic fillers is energy required to dry these fillers prior to compounding with the plastic. Failure to remove absorbed or adsorbed water from the cellulosic fillers would result in voids in the finished product due to volatilization of the water at the processing temperatures. Talc is known for reinforcement for thermoplastics. The reinforcing character of talc is due to its high aspect ratio, organophilic nature, and nucleating ability. Talc has less than 0.2% adsorbed water, is not hygroscopic, and requires no drying prior to compounding. Talc is an extremely soft mineral with a Mohs hardness of one thus reducing wear on processing equipment such as profile extrusion dies.

Others have disclosed cellulosic composite products which include an inorganic, non-hygroscopic material such as talc. Talc replaces a portion of the cellulosic material and/or polymer in such composites which are disclosed in, for example, U.S. Pat. Nos. 6,337,138; 6,235,367; 6,207,729; 5,650,224; 5,937,521; and U.S. Patent Applications 2002/0016388; 2002/0192401. In particular, U.S. Pat. No. 6,337,138 teaches the addition of talc from about 1% to about 20% by weight. However, the composites and articles as taught by these references do not wholly solve the problems inherent in including cellulosic material into a polymeric composition.

For example, composites taught by these references retain sensitivity to moisture as measured by weight gain and thickness swell upon water immersion. Additionally, talc adds a significant amount of weight to the composite. To compensate, it is desirable to increase the mechanical properties of the composite so as to give manufacturers an option to reduce weight of the composite product by reducing the product thickness. Additionally, it is desirable to decrease the melt viscosity in order to provide for ease of manufacturing of the composite. For example, in extrusion lower viscosity imparted by replacement of cellulosic filler with talc allows manufacturer to decrease operating temperatures and reduce possibility of thermal degradation of the cellulosic filler. In the case of molded shapes, the lower viscosity due to talc provides the manufacturer with various operating options such as lower molding pressures and/or lower melt temperatures. A product with a lower melt viscosity would therefore impart a greater ease of manufacture.

In light of the shortcomings of the composites taught in the art, there is a need for cellulosic talc polymer composites with improved moisture resistance characteristics. Another need exists for a cellulosic talc composites that have improved mechanical properties in order to allow for reduced thickness of the composite product, and composites having a lower melt viscosity, leading to a greater ease of manufacture. There is also a need for a method of making improved composite products with these properties. These and other needs are answered by the present invention.

### SUMMARY OF THE INVENTION

The levels of talc and filler in composites as taught by the present invention provide several unexpected advantages over the composites known in the art. For example, the invention's composites have improved mechanical properties such as the modulus of elasticity and the modulus of rupture. This provides the manufacturer with the option of reducing the product thickness, i.e., downgaging the product. The replacement of cellulosic material with talc also increases the heat deflection temperature and improves the creep performance. These mechanical properties are maximized at levels of talc above those disclosed in U.S. Pat. No. 6,337,138. In addition, levels of talc substitution as disclosed by the present invention provides for less moisture sensitivity of the composites, measured by weight gain and thickness swell during water immersion. These properties are useful to ensure a long product life. Manufacturing processes are simplified by the reduced melt viscosity of the composites of the invention, combined with an increase of linear throughput in the case of flood fed twin-screw extrusion.

One embodiment of the present invention is a cellulosic, inorganic-filled plastic composite that includes about 20% to about 40% by weight of the composite of talc, about 10% to about 60% by weight of the composite of cellulosic material, and about 20% to about 70% by weight of the composite of thermoplastic polymer, wherein the total amount of talc and cellulosic material comprises about 30% to about 80% of the composite. As used herein, the term “filler” refers to the combination of cellulosic material and talc. In alternative embodiments, the cellulosic material can be present in an amount from about 15% to about 50%, or from about 20% to about 45%, by weight of the composite. Preferably, the cellulosic material is about 33% by weight. In alternative embodiments, the talc can be present in an amount from about 22% to about 35%, and from about 24% to about 30% by weight of the composite. Preferably, the talc is present in an amount of about 27% by weight of the composite. In alternative embodiments, the filler can be present in an amount from about 40% to about 70%, from about 55% to about 65% by weight of the composite. Preferably, the filler is present in an amount of about 60% of the composite. In alternative embodiments, the thermoplastic polymer can be present in an amount from about 30% to about 55%, or from about 35% to about 45%, by weight of the composite. Preferably, the thermoplastic polymer is present in an amount of about 40% by weight of the composite.

In one embodiment, the cellulosic material can be selected from sawdust, alfalfa, wheat pulp, wood chips, wood particles, ground wood, wood flour, wood flakes, wood veneers, wood laminates, paper, cardboard, straw, cotton, peanut shells, bagass, plant fibers, bamboo fiber, palm fibers, bast, leaves, newspaper, coconut shells, and seed fibers, and is preferably wood flour. In another embodiment, the talc has a purity of about 55% by weight to about 99.9% by weight. In a further embodiment, the thermoplastic polymer is a polyolefin or a polymer selected from high density polyethylene (HDPE), low density polyethylene (LDPE), linear low density polyethylene (LLDPE), polypropylene (PP), thermoplastic polyester, polyvinyl chloride (PVC), nylons, polyurethane repolymers, polystyrene, and acrylics, and combinations thereof. In one embodiment, the thermoplastic polymer is high density polyethylene.

In another embodiment, the cellulosic, inorganic-filled plastic composite can also include an additive which can be selected from a lubricant, a process aid, a cross-linking agent, a coupling agent, a fungicide, a flame retardant, a color pigment, a blowing or foaming agent, and a combination thereof. When the additive is a lubricant, it can be include zinc stearate and EBS wax. Some embodiments include an additive in an amount of less than about 10% by weight of the thermoplastic polymer or at about 3% by weight of the thermoplastic polymer.

In other embodiments, the modulus of elasticity of the composite is at least about 4000 Mpa and in this embodiment, and can include about 27% by weight of talc about 60% by weight filler. In another embodiment, the modulus of rupture of the composite is at least about 24 Mpa, and in this embodiment, and can include about 27% by weight of talc and about 60% by weight filler. In another embodiment, the heat deflection temperature of the composite is at least about 106° F., and in this embodiment, the composite can include about 27% by weight of talc and about 60% by weight filler. In a further embodiment, the creep deformation of the composite, over 24 hours with midpoint load of 450 psi on a span of 6 inches, is less than about 0.025 inches, and in this embodiment, the composite can include about 27% by weight of talc and about 60% by weight filler. In another embodiment, the weight gain of the composite due to water absorption after 1000 hours of water immersion is less than about 15% by weight, and in this embodiment, the composite can include about 27% by weight of talc and about 60% by weight filler. In another embodiment, the thickness swell of the composite in response to 1000 hours of water immersion is less than about 15%, and in this embodiment, the composite can include about 27% by weight of talc and about 60% by weight filler. In another embodiment, the output of the composite in a flood fed extruder is at least about 15 inches per minute and the composite can include about 27% by weight of talc about 60% by weight filler.

In an alternative embodiment, the composite has a hollow core. In addition, the composite can be in the form of an article selected from panels, pipes, decking materials, boards, housings, sheets, poles, straps, fencing, members, doors, shutters, awnings, shades, signs, frames, window casings, backboards, wallboards, flooring, tiles, railroad ties, forms, trays, tool handles, stalls, dispensers, staves, totes, barrels, boxes, packing materials, baskets, racks, casings, binders, dividers, walls, frames, bookcases, sculptures, chairs, tables, desks, art, toys, games, wharves, piers, boats, masts, septic tanks, automotive panels, substrates, computer housings, above- and below-ground electrical casings, furniture, picnic tables, tents, playgrounds, benches, shelters, sporting goods, bedpans, plaques, trays, hangers, servers, pools, insulation, caskets, bookcovers, canes, and crutches.

Another embodiment of the present invention is an article that includes the cellulosic, inorganic-filled plastic composite of the invention. The article may be formed by methods known in the plastics forming arts, including methods such as compression molding, injection molding, thermoforming, and calendaring. Preferably, the article is formed by extrusion. Extrusion may be carried out by a twin screw or single screw extruder. Articles which may be formed include panels, pipes, decking materials, boards, housings, sheets, poles, straps, fencing, members, doors, shutters, awnings, shades, signs, frames, window casings, backboards, wallboards, flooring, tiles, railroad ties, forms, trays, tool handles, stalls, dispensers, staves, totes, barrels, boxes, packing materials, baskets, racks, casings, binders, dividers, walls, mats, frames, bookcases, sculptures, chairs, tables, desks, art, toys, games, wharves, piers, boats, masts, septic tanks, automotive panels, substrates, computer housings, above- and below-ground electrical casings, furniture, picnic tables, tents, playgrounds, benches, shelters, sporting goods, beds, bedpans, plaques, trays, hangers, servers, pools, insulation, caskets, bookcovers, canes, and crutches.

A further embodiment of the invention is a method for extruding a composite that includes introducing a composite into an extruder, melting the composite, extruding the melted composite through a die to form an extrudate, and cooling the extrudate. In this embodiment, the composite includes about 20% to about 40% by weight of the composite as talc, about 10% to about 60% by weight of the composite as cellulosic material, about 20% to about 70% by weight of the composite as thermoplastic polymer, wherein the total amount of talc and cellulosic material comprises about 30% to about 80% by weight of the composite.

### DETAILED DESCRIPTION

The levels of talc and cellulosic material, or of talc and filler, in composites as taught by the present invention provide improved mechanical properties such as the modulus of elasticity and the modulus of rupture. This improvement provides the manufacturer with the option of reducing the product thickness, i.e., downgaging the product. The present invention also provides improved heat deflection temperature and improves the creep performance. In addition, levels of talc substitution as disclosed by the present invention provides for decreased moisture sensitivity (therefore increasing product life) of the composites of the invention, as measured by weight gain and thickness swell during water immersion. Manufacturing processes for the present invention are simplified by the reduced melt viscosity and finished product costs are reduced due to the increase of linear throughput in the case of flood fed twin-screw extrusion.

The present invention requires greater amounts of talc than taught previously and improves the performance of composites based upon cellulosic materials and thermoplastic polymers. The replacement of the cellulosic material with talc results in an improvement in the following properties of the composite: modulus of elasticity (MOE), modulus of rupture (MOR), heat deflection temperature (HDT), creep deformation, and water resistance. In addition, the replacement of cellulosic material with talc results in a reduction in the melt viscosity.

The concentration of talc in composites of the present invention depends upon the percentage of filler, type and amount of lubricant or additive, and the property which one wants to maximize. For economical considerations and mechanical performance, the most preferred composites of the present invention have between about 55% and about 65 wt. % filler. Levels of talc in the present invention are greater than about 20 wt % of the composite.

Composite materials of the present invention are particularly suitable for use where exposure results in elevated temperatures such as a deck board during the summer because of improvements in the HDT due to talc. It has been found that when talc is present in composite materials at levels above about 20% by weight, significant improvements in HDT can be achieved.

Composite materials of the present invention are also particularly suitable for use where exposure to water and/or high humidity because of improvements relating to lessened weight gain and thickness swell due to water immersion. It has been found that when talc is present in composite materials at levels above about 20 wt. %, provide significant improvements in reduction of water absorbed can be achieved.

Another advantage of composite materials of the present invention is improved creep performance, i.e., deformation under load as a function of time. Significant improvements in creep performance are seen in composite materials of the present invention when talc is above about 20 wt. %.

Composite materials of the present invention are particularly well suited for manufacturing processes because of reductions in the melt viscosity due to talc. It has been found that when talc is present in composite materials at levels above about 20% by weight, melt viscosity is reduced, causing increased output during extrusion. This is advantageous for increasing the ease of manufacturing.

Talc increases the specific gravity of the compound approximately 0.5% per percent of cellulosic material replaced, rendering the resultant product heavier. The improved mechanical properties of the composites of the present invention allow for thickness reduction to offset the greater specific gravity seen at talc concentration of about 20% by weight and above. The present invention also provides for hollow core profile and/or foamed products to offset the weight increase due to talc.

The present invention includes a cellulosic, inorganic-filled plastic composite which includes between about 20% to about 40% by weight of the composite of talc; between about 10% to about 60% by weight of the composite of cellulosic material; between about 30% and 80% by weight of the composite of filler; and between about 20% to about 70% by weight of the composite of a thermoplastic polymer.

In a preferred embodiment, the cellulosic material is present in an amount of between about 15% to about 50% by weight of the composite; between about 20% to about 45% by weight of the composite; preferably between about 25% to about 40% by weight of the composite; preferably between about 30% to about 35% by weight of the composite; and most preferably about 33% by weight of the composite. When determining the optimum amount of cellulosic material to create a particular property in a composite, the amount of filler must also be taken into account. For example, see Table 1 and the Examples section.

TABLE 1
Predicted MOE and MOR derived by statistical analysis for various
amounts of filler, talc, and cellulosic material. See Example 2.
Optimum amount of talc or cellulosic material is function of total
filler amount, i.e., wood % + talc %. MOE is maximum for total
filler loading. In addition, the MOR is not as sensitive to talc %
as MOE. Lubricant is at 3%.

| | | Cellulosic | | |
|---|---|---|---|---|
| Filler wt % | Talc wt % | material wt % | MOE, MPa | MOR, MPa |
| 55 | 23 | 32 | 4326 | 28.8 |
| 57 | 25 | 32 | 4514 | 28.7 |
| 60 | 27 | 33 | 4743 | 28.3 |
| 62 | 30 | 32 | 4858 | 27.8 |
| 65 | 33 | 32 | 4978 | 27.0 |

The cellulosic material can be any cellulosic material known in the art for inclusion into plastic composites. It should be recognized that cellulosic material is available in many different forms, and specifically preferred cellulosic materials are sawdust, alfalfa, wheat pulp, wood chips, wood particles, ground wood, wood flour, wood flakes, wood veneers, wood laminates, paper, cardboard, straw, cotton, peanut shells, bagass, plant fibers, bamboo fiber, palm fibers, bast, leaves, newspaper, coconut shells, and seed fibers. Particularly preferred is a finely milled cellulosic flour. Even more particularly preferred is wood flour, and most preferred is a 60 mesh pine wood flour.

The plastic polymer can be any suitable thermoplastic polymer or resin. Preferred thermoplastic polymers are polyolefins such as high density polyethylene (HDPE), low density polyethylene (LDPE), linear low density polyethylene (LLDPE), polypropylene (PP), thermoplastic polyester, polyvinyl chloride (PVC), nylons, polystyrene, and acrylics, or combinations thereof. A composition of 100% HDPE is preferred. Virgin and recycled thermoplastic polymers may be used. Recycled thermoplastic polymers may be obtained from both post-consumer and post-industrial sources.

The amount of thermoplastic polymer to use in the present composite materials can vary between about 20% and about 70% by weight of the composite. Preferably, the amount of thermoplastic polymer is between about 30% and about 55% by weight of the composite, more preferably between about 35% and about 45% by weight of the composite, and most preferably about 40% by weight of the composite.

The present invention also includes talc as part of the composite. Talc is naturally occurring mineral with a platy morphology. Talc can be processed for use in the present invention by any suitable method. For example, talc ore can be milled or ground in a roller mill (“RL”). Here, the talc ore is ground between a roller and a ring. The ground product is classified such that talc particles of a desired size pass out of the RM whereas the oversize particles drop back into the RM and are subjected to additional grinding. RM grinding can produce products ranging for 100 to 325 mesh. For finer products, the RM can be used to supply the feed for various types of micronizing equipment. Talc has less than 0.2% adsorbed water and is not hygroscopic. It requires no drying prior to compounding. Many grades and particle sizes of talc are compatible with the present invention. A preferred talc to use is 325 mesh high purity talc (about 98%) microcrystalline talc (4 hegman topsize). The purity of the talc can vary between about 55% and between about 99.9% by weight depending on the source and the economics.

In a preferred embodiment, the talc is present in an amount of between about 20% to about 40% by weight of the composite; between about 22% to about 35% by weight of the composite; more preferably between about 24% to about 30% by weight of the composite; most preferably, the amount of talc present in the composite is between about 25% and about 28% by weight of the composite. In a particularly preferred embodiment, the talc is present at about 27% by weight of the composite. As noted above, one skilled in the art will appreciate that optimum concentration depends on the amount of filler and the property that manufacturer wants to optimize. See Table 1 and Examples.

In alternative embodiments, the composite of the present invention further comprises an additive. Examples of additives include a lubricant, a process aid, a cross-linking agent, a fungicide, a flame retardant agent, a coupling agent, a blowing agent, a foaming agent, a color pigment, and other additives known in the art, and combinations thereof. Preferred additives include a lubricant, a coupling agent, a foaming agent, and a blowing agent. A more preferred additive includes a lubricant. A preferred lubricant is a combination of zinc stearate and ethylene-bis-stearamide (EBS) wax, preferably in a ratio of about 1:2. Preferably, the amount of the additive in the composite, when used, can vary and is typically between about 1% and about 10% by weight of thermoplastic polymer. Most preferably, the amount of additive to add to the composite is about 3% by weight of thermoplastic polymer. The amount of additive to use may be determined by one skilled in the art considering such factors as the final composition, properties desired, type of cellulosic material, type of talc, type of polymer, and extrusion die design. Zinc stearate/EBS wax is currently standard in the industry.

The composite can be formed into any number of profile shapes. In order to minimize the weight of the composite, the composite may be molded in such a way as to leave spaces or hollow areas within the profile. For example, the composite may be formed such that it has a hollow core or may be foamed. Many other shapes and profiles are known in the art to minimize weight of an article while maintaining the article's structural stability and strength, and such shapes and profiles are included in the present invention. The composite can have an appearance similar to wood and may be sawed, sanded, shaped, turned, fastened and/or finished in the same manner as natural wood.

The composite of the present invention may be in the form of one of the following articles: panels, pipes, decking materials, boards, housings, sheets, poles, straps, fencing, members, doors, shutters, awnings, shades, signs, frames, window casings, backboards, wallboards, flooring, tiles, railroad ties, forms, trays, tool handles, stalls, bedding, dispensers, staves, totes, barrels, boxes, packing materials, baskets, racks, casings, binders, dividers, walls, mats, frames, bookcases, sculptures, chairs, tables, desks, art, toys, games, wharves, piers, boats, masts, septic tanks, automotive panels, substrates, computer housings, above- and below-ground electrical casings, furniture, picnic tables, tents, playgrounds, benches, shelters, sporting goods, bedpans, plaques, trays, hangers, servers, pools, insulation, caskets, bookcovers, canes, and crutches, and other articles known in the art compatible with the structural and mechanical properties of the composite provided the structural requirements do not exceed the physical properties of the composite via known plastics shaping operations. Any known plastics shaping operations are compatible with the present invention, and include compression molding, injection molding, thermoforming, calendaring, and extrusion. Extrusion is a preferred method by which to form articles from composites of the present invention.

The present invention also includes an article made by any known plastics forming process, such as compression molding, injection molding, thermoforming, and calendaring. Extrusion is preferred. A preferred method for extruding a composite of the present invention is as follows. A composite of the present invention may be introduced into an extruder and melted. Alternatively, a partially pre-melted composite may be placed into the extruder. The melted composite is then extruded through a die to form an extrudate, and the extrudate is cooled or allowed to cool. More specifically, in a preferred example, the cellulosic material is preferably dried to between about 0.5% to about 3% moisture content, and more preferably less than about 1% in moisture content. The thermoplastic, preferably in the form of powder or pellets, is added, along with the talc and additives, if any. The mixture can be blended in a low intensity mixer such as a drum mixer. The composite may then be melted and then extruded using an extruder known in the art, such as a counter-rotating, intermeshing conical twin-screw extruder such as a Cincinnati MILACRON CMT 35. The mixture may be fed into the extruder by force feeding, such as by screws. Other types of hoppers (such as a gravity feed hopper) can be used. A vacuum is preferably applied downstream of the vent to further reduce the moisture and remove other volatiles in the mixture. The extruder preferably forces the composite through a die or die system to obtain a final profile shape. The barrel and screw temperature can be about 154° C. with the die at about 162° C., although the temperatures of the barrel and the die may be varied to obtain optimal results for a particular extrusion.

Composites of the present invention preferably have a number of mechanical, thermal, and other properties resulting from, or related to, the composition of the composite. Preferably, a composite of the present invention will have a flexural modulus of at least about 4000 mPa, at least about 4500 mPa, or at least about 4700 mPa. Such preferred compositions typically have talc in a range of between about 20% and about 40% by weight of the compositite, a lubricant in a range of about 1% and about 5% by weight of thermoplastic polymer, cellulosic material in a range of about 10% to about 55% by weight of the composite, filler in the range of about 30% and about 80% by weight of the composite, with the remainder being thermoplastic polymer. A preferred composite will have an amount of lubricant at about 3% by weight of the thermoplastic polymer, an amount of talc at about 27% by weight of the composite, an amount of cellulosic material at about 33% by weight of the composite, and an amount of filler at about 60% by weight of the composite. One of skill in the art will appreciate that there is a variety of proportions of talc, cellulosic fiber, and additive which will yield a flexural modulus of at least about 4000 mPa. See Examples.

Preferably, a composite of the present invention will have a modulus of rupture of at least about 24 mPa, at least about 26 mPa, or most preferably at least about 28 mPa. Such preferred compositions typically have talc in a range of between about 20% and about 40% by weight of the composite, a lubricant in a range of about 1% and 5% by weight of the thermoplastic polymer, cellulosic material in a range of about 10% to about 60% by weight of the composite, filler in the range of about 30% and about 80% by weight of the composite, with the remainder being thermoplastic polymer. A preferred composite will have an amount of lubricant at about 3% by weight of the polymer, an amount of talc at about 27% by weight of the composite, an amount of cellulosic material at about 33% by weight of the composite, and an amount of filler at about 60% by weight of the composite. However, one of skill in the art will appreciate that there is a variety of proportions of talc, cellulosic fiber, and additive, which will yield a modulus of rupture of at least about 24 mPa. See Examples.

Preferably, a composite of the present invention will have a heat deflection temperature, at 66 psi, of at least about 106° F., at least about 107° F., or at least about 109° F. Such preferred compositions typically have talc in a range of between about 20% and about 40% by weight of the composite, a lubricant in a range of about 1% and 5% by weight of the thermoplastic polymer, cellulosic material in a range of about 10% to about 60% by weight of the composite, filler in the range of about 30% and about 80% by weight of the composite, with the remainder being thermoplastic polymer. A preferred composite will have an amount of lubricant at about 3% by weight of the polymer, an amount of talc at about 27% by weight of the composite, an amount of cellulosic material at about 33% by weight of the composite, and an amount of filler at about 60% by weight of the composite. One of skill in the art will appreciate that there is a variety of proportions of talc, cellulosic fiber, and additive which will yield a heat deflection temperature of at least about 106° F. One of skill in the art must bear in mind that although the heat deflection temperature continues to increase as the ratio of talc increases, the amount of talc to include must be determined in light of talc's other properties, such as the increased weight of talc relative to cellulosic materials. See Examples.

Preferably, a composite of the present invention will have a weight gain due to water absorption, after 1000 hours of immersion, as follows. The inventors have found that the amount of lubricant is not a significant variable for weight gain due to water absorption. One of skill in the art will appreciate that there is a variety of proportions of talc, cellulosic fiber, and additive that will yield lower weight gain after immersion. See Examples. One of skill in the art must bear in mind that although water absorption continues to lessen with increased amounts of talc, the amount of talc and filler to include must be determined in light of the cellulosic material's and talc's other properties, such as the increased weight of talc relative to cellulosic material. Preferably, the composite will have no more than about an 15 percent increase of weight, no more than about 10 percent increase of weight, or no more than about a 5 percent increase of weight. Such preferred compositions typically have talc in a range of between about 20% and about 40% by weight of the composite, a lubricant in a range of about 1% and 5% by weight of the thermoplastic polymer, cellulosic material in a range of about 10% to about 60% by weight of the composite, filler in the range of about 30% and about 80% by weight of the composite, with the remainder being thermoplastic polymer. A preferred composite will have an amount of lubricant at about 3% by weight of the polymer, an amount of talc at about 27% by weight of the composite, an amount of cellulosic material at about 33% by weight of the composite, and an amount of filler at about 60% by weight of the composite.

Preferably, a composite of the present invention will have thickness swell, after 1000 hours of immersion, as follows. One of skill in the art will appreciate that there is a variety of proportions of talc, cellulosic fiber, and additive which will yield a minimum thickness swell. See Examples. One of skill in the art must bear in mind that although water absorption continues to lessen with increased amounts of talc, the amount of talc and filler to include must be determined in light of the cellulosic material's and talc's other properties, such as the increased weight of talc relative to cellulosic material. Preferably, the composite will have no more than about a 15 percent swell, no more than about a 12 percent swell, no more than about a 9 percent swell. Such preferred compositions typically have talc in a range of between about 20% and about 40% by weight of the composite, a lubricant in a range of about 1% and 5% by weight of the thermoplastic polymer, cellulosic material in a range of about 10% to about 60% by weight of the composite, filler in the range of about 30% and about 80% by weight of the composite, with the remainder being thermoplastic polymer. A preferred composite will have an amount of lubricant at about 3% by weight of the polymer, an amount of talc at about 27% by weight of the composite, an amount of cellulosic material at about 33% by weight of the composite, and an amount of filler at about 60% by weight of the composite.

Preferably, a composite of the present invention will have a creep deformation of the composite, over 24 hours under a midpoint load 450 psi with 6 inch span, of less than about 0.025 inches, of less than about 0.020 inches, or of less than about 0.015 inches. Such preferred compositions typically have talc in a range of between about 20% and about 40% by weight of the composite, a lubricant in a range of about 1% and 5% by weight of the thermoplastic polymer, cellulosic material in a range of about 10% to about 60% by weight of the composite, filler in the range of about 30% and about 80% by weight of the composite, with the remainder being thermoplastic polymer. A preferred composite will have an amount of lubricant at about 3% by weight of the polymer, an amount of talc at about 27% by weight of the composite, an amount of cellulosic material at about 33% by weight of the composite, and an amount of filler at about 60% by weight of the composite. However, one of skill in the art will appreciate that there is a variety of proportions of talc, cellulosic fiber, and additive which will yield a creep deformation of no more than about 0.025 inches under conditions described above. One of skill in the art must bear in mind that although creep deformation improves with increasing talc, the amount of talc and filler to include must be determined in light of the cellulosic material's and talc's other properties, such as the increased weight of talc relative to cellulosic material.

Preferably, a composite of the present invention will have a reduced melt viscosity and corresponding increase in output in a flood fed extruder. A preferred composite of the present invention will have a linear output of at least about 15 inches/minute, at least about 17 inches/minute, or at least about 19 inches/minute at 12 rpms on Cincinnati Milacron CMT 35 counter-rotating, intermeshing conical twin screw extruder with screws which were designed for wood/polymer blends and a 1.5×0.375 inch rectangular die. Such preferred compositions typically have talc in a range of between about 20% and about 40% by weight of the composite, a lubricant in a range of about 1% and 5% by weight of the thermoplastic polymer, cellulosic material in a range of about 10% to about 60% by weight of the composite, filler in the range of about 30% and about 80% by weight of the composite, with the remainder being thermoplastic polymer. A preferred composite will have an amount of lubricant at about 3% by weight of the polymer, an amount of talc at about 27% by weight of the composite, an amount of cellulosic material at about 33% by weight of the composite, and an amount of filler at about 60% by weight of the composite. However, one of skill in the art will appreciate that there is a variety of proportions of talc, cellulosic fiber, and additive which will yield a linear output of at least about 15 inches/minute. See Examples. One of skill in the art must bear in mind that although melt viscosity improves for compositions occurs with increasing talc concentrations, the amount of talc to include must be determined in light of the talc's other properties, such as the increased weight of talc relative to cellulosic materials.

The present invention, while disclosed in terms of specific methods, products, and organisms, is intended to include all such methods, products, and organisms obtainable and useful according to the teachings disclosed herein, including all such substitutions, modifications, and optimizations as would be available to those of ordinary skill in the art. The following examples and test results are provided for the purposes of illustration and are not intended to limit the scope of the invention.

### EXAMPLES

### Example 1

The following example describes the preparation of the samples for testing a variety of physical parameters of compositions of the present invention.

The effect of the following variables on the properties of cellulosic-plastic composites was investigated: the amount of talc, the amount of cellulose, the amount of filler, the amount of thermoplastic polymer, and amount of lubricant. The thermoplastic polymer was 0.4 MF HDPE (obtained from Equistar); the talc was 4 Hegman macrocrystalline product (MISTROFIL P403 from Luzenac America, Inc.); the lubricant was a blend of zinc stearate and EBS wax in a ratio of 2:1; and cellulosic material was softwood pine flour, 60 mesh pine wood flour from American Wood Fibers. Table 2 gives the amounts of each component per formulation.

The composite materials were extruded into ⅜×1.5 inch boards using the following process. The wood flour was pre-dried to a moisture level of less than 1.0%. The formulations were blended in a drum mixture using a powdered HDPE resin. These were then compounded in a counter-rotating, intermeshing conical twin screw extruder (Cincinnati MILACRON CMT 35) equipped with screws, which were designed specifically for cellulose/polymer mixtures. The screws have deep channels in the solid conveying section to accommodate the low bulk densities of the blends and a minimum number of shear elements in order to avoid degradation of the cellulose. The screws have a minimum diameter of 35 mm and a L/D of approximately 22.5 to 1. The barrel and screw temperature was 154 C with the die at 162 C. A vacuum (29 in Hg) was pulled in the second section of the extruder to remove any volatiles. The extrudate was cooled in a spray tank. The rough edges of the boards were removed with a planer to obtain specimens for flexural testing which was done in accordance with ASTM D790 Method I. The resin rich surfaces and rough edges were removed with a planer to prepare specimens for the heat deflection and water absorption testing. The heat deflection temperatures were determined per ASTM D648. The water absorption tests followed ASTM D1037 with the exception that the specimens were removed from the water after 168, 400, and 1000 hours to measure weight gain and thickness swell.

TABLE 2
Formulations

| Run | HDPE | Wood | Talc | Lubricant |
|---|---|---|---|---|
| No. | (gms) | (gms) | (gms) | (gms) |
| 1 | 47.4 | 39.7 | 9.9 | 3.0 |
| 2 | 27.85 | 55.32 | 13.83 | 3.0 |
| 3 | 43.76 | 26.62 | 26.62 | 3.0 |
| 4 | 24.9 | 36.05 | 36.05 | 3.0 |
| 5 | 47.6 | 33.4 | 18.0 | 1.0 |
| 6 | 28.41 | 45.88 | 24.71 | 1.0 |
| 7 | 43.6 | 33.4 | 18.0 | 5.0 |
| 8 | 24.41 | 45.88 | 24.71 | 5.0 |
| 9 | 39.0 | 48.0 | 12.0 | 1.0 |
| 10 | 35.63 | 31.68 | 31.67 | 1.0 |
| 11 | 35.0 | 48.0 | 12.0 | 5.0 |
| 12 | 31.63 | 31.68 | 31.67 | 5.0 |
| 13 | 35.36 | 40.06 | 21.57 | 3.0 |
| 14 | 35.36 | 40.06 | 21.57 | 3.0 |
| 15 | 38.01 | 53.09 | 5.90 | 3.0 |
| 16* | 38.01 | 53.09 | 5.90 | 3.0 |
| Purge* | 31.00 | 58.00 | 8.00 | 3.0 |

Note:
*hardwood (maple) used in place of softwood (pine).
1) HDPE is 0.4 MF product
2) talc is 4 Hegman macrocrystalline product from Luzenac America Inc.
3) lubricant is blend of zinc stearate and EBS wax in a ratio of 2:1

### Example 2

This Example describes the analysis of the effect of talc on flexural modulus, modulus of rupture (maximum stress at failure) and heat deflection temperature.

The composites for testing were prepared as described in Example 1 (Runs 1-15) and were subjected to flexural testing in accordance with ASTM D790 Method I. This method provided the data (shown in Table 3) for statistical analysis for calculating flexural modulus (MOE), modulus of rupture (MOR), and maximum heat deflection temperature (HDT) behavior.

Table 2. MOE, MOR, HDT for each formulation.

TABLE 3
Flexural Properties

| | | Run No. | | | | | | | |
|---|---|---|---|---|---|---|---|---|---|
| | | 1 | 2 | 3 | 4 | 5 | 6 | 7 | 8 |
| Vol. % Filler | | 35 | 55 | 35 | 55 | 35 | 55 | 35 | 55 |
| Talc/Wood | | 20/80 | 20/80 | 50/50 | 50/50 | 35/65 | 35/65 | 35/65 | 35/65 |
| Lubricant, % | | 3 | 3 | 3 | 3 | 1 | 1 | 5 | 5 |
| MOE, Mpa | Mn | 3,086 | 3,588 | 3,896 | 4,951 | 3,453 | 5,272 | 4,083 | 3,962 |
| | Std | 286 | 149 | 253 | 294 | 201 | 115 | 96 | 230 |
| MOR, Mpa | Mn | 25.2 | 17.8 | 27.7 | 22.1 | 28.1 | 26.8 | 26.5 | 19.0 |
| | Std | 0.28 | 0.46 | 0.69 | 0.51 | 0.55 | 0.24 | 0.27 | 0.8 |
| Max | Mn | 0.342 | 0.151 | 0.324 | 0.120 | 0.350 | 0.145 | 0.267 | 0.119 |
| Deflection, | Std | 0.025 | 0.011 | 0.010 | 0.010 | 0.031 | 0.005 | 0.014 | 0.012 |
| (HDT) in | | | | | | | | | |

| | | Run No. | | | | | | |
|---|---|---|---|---|---|---|---|---|
| | | 9 | 10 | 11 | 12 | 13 | 14 | 15 |
| Vol. % Filler | | 45 | 45 | 45 | 45 | 45 | 45 | 45 |
| Talc/Wood | | 20/80 | 50/50 | 20/80 | 50/50 | 35/65 | 35/65 | 10/90 |
| Lubricant, % | | 1 | 1 | 5 | 5 | 3 | 3 | 3 |
| MOE, Mpa | Mn | 4,321 | 4,850 | 3,829 | 4,712 | 4,580 | 4,686 | 3,768 |
| | Std | 126 | 266 | 160 | 143 | 169 | 49 | 158 |
| MOR, Mpa | Mn | 27.3 | 29.1 | 20.6 | 23.6 | 25.8 | 25.9 | 22.8 |
| | Std | 0.23 | 0.53 | 0.47 | 0.56 | 0.67 | 0.23 | 0.71 |
| Max | Mn | 0.214 | 0.218 | 0.180 | 0.151 | 0.188 | 0.182 | 0.221 |
| Deflection, | Std | 0.006 | 0.011 | 0.011 | 0.010 | 0.013 | 0.008 | 0.018 |
| (HDT) in | | | | | | | | |

Notes:
1) maximum stress = stress at failure = modulus of rupture, i.e., max load/cross sectional area.
Abbreviations: Mn = mean and Std = standard deviation.

A. Flexural Modulus

The data in Table 3 was subjected to statistical analysis. At a lubricant level of 3%, flexural modulus increases with filler loading and talc percentage and the maximum MOE is achieved at 27% talc. The increase in flexural modulus is roughly 1% for each percent of cellulosic material replaced with talc. See Table 4.

TABLE 4
Predicted Values vs. Talc Ratio at 55 vol. % Filler

| | Talc/Wood | | | | | |
|---|---|---|---|---|---|---|
| | 10/90 | 50/50 | 10/90 | 50/50 | 10/90 | 50/50 |
| Lubricant, % | 1 | 1 | 3 | 3 | 5 | 5 |
| Wt. % of Talc | 6.8 | 36.0 | 6.8 | 36.0 | 6.8 | 36.0 |
| Flex Modulus, Mpa | 4104 | 5556 | 3537 | 4989 | 2971 | 4423 |
| % Increase in Flex Mod | | 35 | | 41 | | 49 |
| Mod of Rupture, Mpa | 21.4 | 27.6 | 22.8 | 24.2 | 13.9 | 20.1 |
| % Increase in MOR | | 29 | | 38 | | 45 |

It is believed that most commercial products will be in the range of about 55 to 65% filler. At 50% filler, we observe maximum MOE at less than 20% talc; however, the max MOR occurs at between 20 and 22% talc. At 70% filler, the max MOR is at 35% talc. Foam products have an MOE and MOR very dependent upon the % foaming. Values for foamed products will be significantly less than those in the table, e.g., at 50% filler with 25% talc and 18% foam product has a MOE of 2600 and MOR of 24.7.

TABLE 5
Predicted values v. talc ratio at various percentages of filler,
at 3% lubricant.

| | Filler | Talc | Wood | Maximum | MOR, |
|---|---|---|---|---|---|
| % Polymer + additives | % | % | % | MOE, MPa | MPa |
| 47 | 50 | 15 | 35 | 3815 | 27.0 |
| 48 | 52 | 20 | 32 | 3989 | 28.9 |
| 45 | 55 | 23 | 32 | 4326 | 28.8 |
| 43 | 57 | 25 | 32 | 4514 | 28.7 |
| 40 | 60 | 27 | 33 | 4743 | 28.3 |
| 38 | 62 | 30 | 32 | 4858 | 27.8 |
| 35 | 65 | 33 | 32 | 4978 | 27.0 |
| 30 | 70 | 37 | 33 | 5034 | 24.9 |

B. Modulus of Rupture

The data in Table 3 was subjected to statistical analysis for prediction of modulus of rupture. Tables 4 and 5 show predicted values for MOR depending on filler level and talc amount. At a lubricant level of 3%, as with flexural modulus, the modulus of rupture increases approximately 1% for each percent of cellulosic material replaced with talc, and the maximum MOR is achieved at 28.6% talc. The increase in flexural modulus in roughly 1% for each percent of cellulosic material replaced with talc. See Tables 4 and 5, above.

C. Heat Deflection Temperature

The data in Table 6 generated in accordance with ASTM D648-96 was subjected to statistical analysis for predicting heat deflection temperature. At a lubricant level of 3%, the HDT increases with talc content, but decreases with the amount of filler relative to polymer. With the lubricant at 3%, the maximum HDT is at 52.8% talc. HDT decreases as % lubricant increases. The model for HDT does not suggest a maximum, i.e., it appears to continue to increase with % talc. Table 6 shows measured values for HDT. Tables 7 and 8 show predicted values for HDT.

Table 6

Measured Values For HDT

TABLE 6
Heat Deflection Data

| | Run No. | | | | | | | | | | | | | | |
|---|---|---|---|---|---|---|---|---|---|---|---|---|---|---|---|
| | 1 | 2 | 3 | 4 | 5 | 6 | 7 | 8 | 9 | 10 | 11 | 12 | 13 | 14 | 15 |
| Vol. % Filler | 35 | 55 | 35 | 55 | 35 | 55 | 35 | 55 | 45 | 45 | 45 | 45 | 45 | 45 | 45 |
| Talc/Wood | 20/80 | 20/80 | 50/50 | 50/50 | 35/65 | 35/65 | 35/65 | 35/65 | 20/80 | 50/50 | 20/80 | 50/50 | 35/65 | 35/65 | 10/90 |
| % Lubricant | 3 | 3 | 3 | 3 | 1 | 1 | 5 | 5 | 1 | 1 | 5 | 5 | 3 | 3 | 3 |
| HDT, ° C. | 107.5 | 98.4 | 113.1 | 108.2 | 111.5 | 111.9 | 109.1 | 92.9 | 111.5 | 109.3 | 91.4 | 104.9 | 103.0 | — | 95.6 |

Note:
HDT for hard wood with same composition as run #15 was 108.7° C.

TABLE 7
Predicted Heat Deflection Temperatures at 20% talc

| HDPE | % Talc | % Filler | % LUb | HDT |
|---|---|---|---|---|
| 42 | 20 | 55 | 3 | 108.8 |
| 40 | 20 | 57 | 3 | 107.6 |
| 37 | 20 | 60 | 3 | 105.9 |
| 35 | 20 | 62 | 3 | 104.8 |
| 32 | 20 | 65 | 3 | 103.2 |

TABLE 8
Predicted Heat Deflection Values at 27% talc

| HDPE | % Talc | % Filler | % LUb | HDT |
|---|---|---|---|---|
| 42 | 27 | 55 | 3 | 112 |
| 40 | 27 | 57 | 3 | 111 |
| 37 | 27 | 60 | 3 | 109 |
| 35 | 27 | 62 | 3 | 108 |
| 32 | 27 | 65 | 3 | 106 |

### Example 3

This Example describes the analysis of the effect of talc on water absorption and thickness swell.

The composites for testing were prepared as described in Example 1 (Runs 1-15). The water absorption tests followed ASTM D1037 with the exception that the composites were removed from the water after 168, 400, and 1000 hours to measure weight gain and thickness swell. The 5 inch long specimens with dimensions of 0.25×1.0 inches were prepared from the 0.375×1.5 inch boards with a planer to remove any rough edges and resin rich surfaces.

Table 9 shows the data generated.

TABLE 9
Water Absorption Data after 1000 hrs of Exposure

| | | Run No. | | | | | | | |
|---|---|---|---|---|---|---|---|---|---|
| | | 1 | 2 | 3 | 4 | 5 | 6 | 7 | 8 |
| Vol. % Filler | | 35 | 55 | 35 | 55 | 35 | 55 | 35 | 55 |
| Talc/Wood | | 20/80 | 20/80 | 50/50 | 50/50 | 35/65 | 35/65 | 35/65 | 35/65 |
| Lubricant, % s | | 3 | 3 | 3 | 3 | 1 | 1 | 5 | 5 |
| Weight | Mn | 5.71 | 18.34 | 2.52 | 9.96 | 4.72 | 14.56 | 4.36 | 15.98 |
| Gain, % | Std. | 0.31 | 0.18 | 0.17 | 0.16 | 0.19 | 0.15 | 0.09 | 0.48 |
| Thickness | Mn | 6.20 | 12.2 | 2.8 | 7.5 | 4.8 | 10.5 | 4.3 | 11.4 |
| Change, % | Std. | 0.08 | 0.75 | 0.09 | 0.34 | 0.57 | 0.52 | 0.21 | 0.65 |
| Volume | Mn | 4.3 | 15.3 | 1.9 | 9.7 | 3.6 | 13.5 | 3.3 | 14.6 |
| Change², % | Std. | 0.27 | 0.15 | 0.10 | 0.14 | 0.06 | 0.93 | 0.40 | 0.46 |
| Warpage³, | Mn | 0.014 | 0.157 | 0.014 | 0.089 | 0.011 | 0.056 | 0.008 | 0.156 |
| in | Std. | 0.0035 | 0.0105 | 0.0040 | 0.0050 | 0.0073 | 0.0045 | 0.0013 | 0.0052 |

| | | Run No. | | | | | | |
|---|---|---|---|---|---|---|---|---|
| | | 9 | 10 | 11 | 12 | 13 | 14 | 15 |
| Vol. % Filler | | 45 | 45 | 45 | 45 | 45 | 45 | 45 |
| Talc/Wood | | 20/80 | 50/50 | 20/80 | 50/50 | 35/65 | 35/65 | 10/90 |
| Lubricant, % s | | 1 | 1 | 5 | 5 | 3 | 3 | 3 |
| Weight | Mn | 12.76 | 6.49 | 13.85 | 5.25 | 7.94 | 8.06 | 15.91 |
| Gain, % | Std. | 0.02 | 0.18 | 0.20 | 0.22 | 0.12 | 0.10 | 0.06 |
| Thickness | Mn | 8.0 | 6.5 | 8.6 | 3.4 | 4.3 | 5.1 | 8.9 |
| Change, % | Std. | 0.47 | 0.57 | 0.73 | 0.20 | 0.86 | 0.69 | 0.39 |
| Volume | Mn | 10.7 | 5.7 | 11.0 | 4.5 | 6.6 | 6.5 | 12.2 |
| Change², % | 0.34 | 0.09 | 0.34 | 0.14 | 0.20 | 0.61 | 0.30 | |
| Warpage³, | 0.023 | 0.003 | 0.086 | 0.033 | 0.029 | 0.034 | 0.0105 | |
| in | Std. | 0.0038 | 0.0028 | 0.0020 | 0.0038 | 0.0030 | 0.0049 | 0.0054 |

Notes:
1) three specimens per sample.
²volume determined per ASTM 0792-91 Method A.
³warpage is defined as the difference in thickness measurement with the specimen in the concave position and specimen simply flipped over and re-measured in the convex position. 4) water changed each time the samples were removed for weighing and dimensional measurements.
4) water temperature was approximately 21 .C.
Abbreviations: Mn = mean and Std = standard deviation.

A. Water Absorption

The data in Table 9 was subjected to statistical analysis. At a lubricant level of 3%, the % weight change upon water immersion increases with filler loading and decreases with talc percentage. The best performance (i.e., least water absorbed) for each amount of filler (cellulosic material+talc) is attained at a talc substitution of greater than 20% talc. Table 10 and 11 show the predicted reduction in weight gain attributable to talc and predicted thickness swell and weight gain, respectively, according to the data in Table 9. Percent talc in line one, Table 10, refers to the percent of talc in filler. Water resistance is dependent on the polymer content and the talc content as shown below.

TABLE 10
Predicted reduction in weight gain due to talc and filler amounts

| | | | | |
|---|---|---|---|---|
| Talc/Wood ratio, % Talc | 10 | 50 | 10 | 50 |
| Vol. % Filler, % | 35 | 35 | 55 | 55 |
| Weight Gain, % | 8.7 | 2.1 | 22.8 | 10.2 |
| Reduction due to Talc, % | | 76 | | 55 |

TABLE 11
Predicted values v. amount of filler and amount of talc

| % Polymer + | | | | | Thickness |
|---|---|---|---|---|---|
| additives | Filler % | Talc % | Wood % | Weight gain | Swell |
| 40 | 60 | 0 | 60 | 18.3 | 10.1 |
| 40 | 60 | 20 | 40 | 8.5 | 5.5 |
| 40 | 60 | 27 | 33 | 5.0 | 3.9 |
| 40 | 60 | 33 | 27 | 2.0 | 2.5 |
| 45 | 55 | 23 | 32 | 3.7 | 3.3 |
| 38 | 62 | 30 | 32 | 4.9 | 3.9 |
| 35 | 65 | 33 | 32 | 5.6 | 4.7 |
| 30 | 70 | 37 | 33 | 7.5 | 6.7 |

B. Thickness Swell

The data in Table 9 was subjected to statistical analysis for thickness swell. At a lubricant level of 3%, the % weight change upon water immersion increases with filler loading and decreases with talc percentage. The best performance (i.e., least water absorbed) for each amount of filler (cellulosic material +talc) is attained at a talc substitution of greater than 20% talc. Table 11 and 12 show the reduction in thickness swell attributable to talc and predicted thickness swell and weight gain, respectively, according to the data in Table 9.

TABLE 12
Predicted reduction in thickness swell due to talc and filler amounts

| | | | | |
|---|---|---|---|---|
| Talc/Wood, % Talc | 10 | 50 | 10 | 50 |
| Vol. % Filler, % | 35 | 35 | 55 | 55 |
| Lubricant conc., % | 3 | 3 | 3 | 3 |
| Change in Thickness, % | 6.6 | 2.8 | 14.6 | 7.6 |
| Reduction due to Talc, % | | 58 | | 48 |

### Example 4

This Example describes analysis of the effect of talc on creep deformation. The data in Table 13 (generated over 24 hours with midpoint load of 450 psi on a span of 6 inches) was subjected to statistical analysis. At a lubricant level of 3%, creep deformation decreases with filler loading and also decreases with talc percentage. The best performance (i.e., least creep) is with higher filler (cellulosic material+talc) amounts and at a talc substitution of greater than 20% talc.

TABLE 13

| | | | | Instantaneous | Total | Creep | Instantaneous | Total | % Total |
|---|---|---|---|---|---|---|---|---|---|
| Specimen | Vol. % | Talc Wood | % Lub | Deflection | Deflection | Deformation | Recovery | Recovery | Recovery |
| 01-1 | 35 | 20/80 | 3 | −0.0163 | −0.0394 | −0.0231 | −0.0196 | −0.0314 | 79.81 |
| 01-2 | | | | −0.0205 | −0.0377 | −0.0173 | −0.0168 | −0.0304 | 80.54 |
| 02-1 | 55 | 20/80 | 3 | −0.0139 | −0.0345 | −0.0206 | −0.0162 | −0.0274 | 79.59 |
| 02-2 | | | | −0.0232 | −0.0404 | −0.0172 | −0.0168 | −0.0303 | 74.89 |
| 03-1 | 35 | 50/50 | 3 | −0.0196 | −0.0336 | −0.0140 | −0.0133 | −0.0285 | 84.75 |
| 03-2 | | | | −0.0211 | −0.0368 | −0.0157 | −0.0153 | −0.0295 | 80.16 |
| 04-1 | 55 | 50/50 | 3 | −0.0190 | −0.0257 | −0.0067 | −0.0104 | −0.0207 | 80.41 |
| 04-2 | | | | −0.0014 | −0.0276 | −0.0263 | −0.0126 | −0.0249 | 90.02 |
| 05-1 | 35 | 35/65 | 1 | −0.0177 | −0.0412 | −0.0234 | −0.0181 | −0.0334 | 81.17 |
| 05-2 | | | | −0.0234 | −0.0405 | −0.0171 | −0.0196 | −0.0338 | 83.45 |
| 06-1 | 55 | 35/65 | 1 | −0.0144 | −0.0218 | −0.0074 | −0.0089 | −0.0177 | 81.21 |
| 06-2 | | | | −0.0222 | −0.0293 | −0.0071 | −0.0145 | −0.0196 | 67.00 |
| 07-1 | 35 | 35/65 | 5 | −0.0151 | −0.0320 | −0.0168 | −0.0193 | −0.0222 | 69.35 |
| 07-2 | | | | −0.0216 | −0.0371 | −0.0155 | −0.0148 | −0.0300 | 80.95 |
| 08-1 | 55 | 35/65 | 5 | −0.0175 | −0.0336 | −0.0161 | −0.0155 | −0.0241 | 71.78 |
| 08-2 | | | | −0.0207 | −0.0347 | −0.0140 | −0.0163 | −0.0251 | 72.39 |
| 09-1 | 45 | 20/80 | 1 | −0.0153 | −0.0338 | −0.0184 | −0.0151 | −0.0253 | 74.95 |
| 09-2 | | | | −0.0178 | −0.0371 | −0.0194 | −0.0186 | −0.0258 | 69.41 |
| 10-1 | 45 | 50/50 | 1 | −0.0176 | −0.0325 | −0.0149 | −0.0161 | −0.0227 | 69.86 |
| 10-2 | | | | −0.0198 | −0.0412 | −0.0214 | −0.0213 | −0.0262 | 63.57 |
| 11-1 | 45 | 20/80 | 5 | −0.0174 | −0.0349 | −0.0174 | −0.0153 | −0.0268 | 76.85 |
| 11-2 | | | | −0.0210 | −0.0384 | −0.0174 | −0.0198 | −0.0294 | 76.57 |
| 12-1 | 45 | 50/50 | 5 | −0.0115 | −0.0335 | −0.0220 | −0.0192 | −0.0217 | 64.87 |
| 12-2 | | | | −0.0214 | −0.0335 | −0.0121 | −0.0155 | −0.0239 | 71.24 |
| 13-1 | 45 | 35/65 | 3 | −0.0199 | −0.0337 | −0.0137 | −0.0183 | −0.0235 | 69.71 |
| 13-2 | | | | −0.0172 | −0.0326 | −0.0154 | −0.0152 | −0.0251 | 76.95 |
| 14-1 | 45 | 35/65 | 3 | −0.0224 | −0.0467 | −0.0242 | −0.0286 | −0.0238 | 51.01 |
| 14-2 | | | | −0.0208 | −0.0342 | −0.0134 | −0.0144 | −0.0277 | 80.84 |
| 15-1 | 45 | 10/90 | 3 | −0.0196 | −0.0405 | −0.0209 | −0.0207 | −0.0288 | 71.16 |
| 15-2 | | | | −0.0214 | −0.0385 | −0.0171 | −0.0203 | −0.0279 | 72.42 |
| 16-1 | 45 | 10/90 | 3 | −0.0272 | −0.0471 | −0.0199 | −0.0227 | −0.0320 | 68.06 |
| 16-2 | | | | −0.0224 | −0.0431 | −0.0207 | −0.0215 | −0.0301 | 69.81 |
| Maple-1 | 45 | 10/90 | 3 | −0.0226 | −0.0388 | −0.0162 | −0.0178 | −0.0284 | 73.24 |
| Maple-2 | | | | −0.0200 | −0.0365 | −0.0165 | −0.0179 | −0.0258 | 70.80 |

Notes:
1) specimens preconditioned at the test conditions (74° F. and 50% RH) for 24 hours.
2) number of specimens per compound limited to two
3) deflection data taken at 30 second intervals using linear variable differential transformer.
4) the following points were considered to be outliers and were not used in analysis: 10-1, 10-2, 4-2, 12-1 and 14-1.

### Example 5

The following Example demonstrates the ability to downgage products made from compositions of the present invention by the replacement of wood flour with talc. The equation to calculate the thickness of one material required to give the same stiffness as a second material is as follows:
h₁/h₂=(E₂/E₁)^{1/3}

h₁=thickness of rectangular beam of material 1

h₂=thickness of rectangular beam of material 2

E₁=flexural modulus of material 1

E₂=flexural modulus of material 2.

In the case of a WPC composed of 37 wt. % HDPE, 3 wt. % lubricant, and 60 wt. % filler, where the filler is a mixture of 6 wt. % talc and 54 wt. % wood flour, the MOE is: E₂(6 wt. % talc)=3543 Mpa. For the same composite, the MOE increases if wood is replaced with talc. In this example, if the talc loading is increased to 26.5 wt. %, the MOE will be: E₁(26.5 wt. % talc)=4757 Mpa. Therefore, the ratio of thickness to maintain the same stiffness is as follows: h₁/h₂=( E₂/E₁)/^{1/3}=(3543/4757)^{1/3}, and h₁/h₂=0.91. Therefore, the thickness of an extruded rectangular profile with 26.5 wt. % can be reduced by 9% without altering the stiffness of the profile.

This corresponds as to 9% reduction in weight as weight is related to thickness by the following equation: W₁/W₂=h₁/h₂. The actual weight change with the replacement of wood with talc is in this case only 1.25% as shown in the following calculation: Weight Change=weight increase due talc−weight reduction due downgaging=20.5(0.5)−9=1.25%.

### Example 6

The following Example demonstrates the reduction in melt viscosity of WPC products with the replacement of wood flour with talc. This is based on capillary rheometer data on compounds from a constrained central composite designed experiment. The statistical model for the melt viscosity as a function of wt. % filler and wt. % talc is as follows:
η=C₁+C₂(wt. % filler)−C₃(wt. % talc), where η=viscosity, Cᵢ=constants.

TABLE 14a

| Run | Weight of | Weight of | Weight of | |
|---|---|---|---|---|
| No. | HDPE (gms) | Wood (gms) | Talc (gms) | Type of Talc |
| 1 | 69.50 | 27.45 | 3.05 | JetFil 575 |
| 2 | 48.97 | 45.93 | 5.10 | JetFil 575 |
| 3 | 65.40 | 17.30 | 17.30 | JetFil 575 |
| 4 | 44.33 | 27.83 | 27.83 | JetFil 575 |
| 5 | 69.50 | 27.45 | 3.05 | FDC |
| 6 | 48.97 | 45.93 | 5.10 | FDC |
| 7 | 65.40 | 17.30 | 17.30 | FDC |
| 8 | 44.33 | 27.83 | 27.83 | FDC |
| 9 | 56.51 | 30.44 | 13.05 | MistroFil P403 |
| 10 | 56.51 | 30.44 | 13.05 | MistroFil P403 |
| 11 | 82.43 | 12.30 | 5.27 | MistroFil P403 |
| 12 | 36.78 | 44.25 | 18.97 | MistroFil P403 |
| 13 | 59.69 | 40.31 | 0.00 | None |
| 14 | 52.80 | 18.88 | 28.32 | MistroFil P403 |
| 15 | 56.51 | 30.44 | 13.05 | JetFil 700 |
| 16 | 56.51 | 30.44 | 13.05 | FDC |

TABLE 14b

| | Run No. | | | | | | | | |
|---|---|---|---|---|---|---|---|---|---|
| | 1 | 2 | 3 | 4 | 5 | 6 | 7 | 8 | 9 |
| Compound No. | 5675 | 5676 | 5677 | 5678 | 5679 | 5680 | 5681 | 5682 | 5683 |
| Vol. % Filler | 20 | 37.25 | 20 | 37.25 | 20 | 37.25 | 20 | 37.25 | 28.625 |
| Talc/Wood | 10/90 | 10/90 | 50/50 | 50/50 | 10/90 | 10/90 | 50/50 | 50/50 | 30/70 |
| mps | 3.4 | 3.4 | 3.4 | 3.4 | 16 | 16 | 16 | 16 | 6.6 |
| Shear Rate | Apparent Melt Viscosity, η × 10⁻⁴ poise | | | | | | | | |
| 3.3875 | 192.6 | 248.2 | 215.1 | 245.5 | 241.6 | 294.5 | 212.5 | 257.5 | 285.3 |
| 11.26 | 103.5 | 139.0 | 104.8 | 146.0 | 119.2 | 167.6 | 102.7 | 132.1 | 140.0 |
| 33.875 | 57.1 | 80.1 | 57.1 | 73.5 | 60.2 | 84.4 | 53.6 | 68.0 | 71.2 |
| 112.6 | 27.8 | 37.2 | 27.3 | 34.4 | 29.8 | 38.6 | 26.7 | 34.4 | 32.8 |
| 338.75 | 13.9 | 17.2 | 13.2 | 16.7 | 14.5 | 17.9 | 13.2 | 17.0 | 15.7 |
| 1126 | 4.5 | 6.3 | 4.9 | 7.5 | 5.6 | 6.4 | 4.9 | 7.2 | 6.2 |

| | Run No. | | | | | | |
|---|---|---|---|---|---|---|---|
| | 10 | 11 | 12 | 13 | 14 | 15 | 16 |
| Compound No. | 5684 | 5685 | 5686 | 5687 | 5688 | 5689 | 5690 |
| Vol. % Filler | 28.625 | 10 | 47.25 | 28.625 | 28.625 | 28.625 | 28.625 |
| Talc/Wood | 30/70 | 30/70 | 30/70 | 0/100 | 60/40 | 30/70 | 30/70 |
| mps | 6.6 | 6.6 | 6.6 | 6.6 | 6.6 | 1.5 | 16 |
| Shear Rate | Apparent Melt Viscosity, η × 10⁻⁴ poise | | | | | | |
| 3.3875 | 254.2 | 234.3 | 213.1 | 317.0 | 289.9 | 296.5 | 264.7 |
| 11.26 | 147.7 | 95.5 | 178.7 | 145.8 | 134.0 | 133.3 | 126.1 |
| 33.875 | 67.5 | 49.8 | 99.1 | 75.1 | 65.5 | 65.9 | 66.1 |
| 112.6 | 32.5 | 24.8 | 44.9 | 34.8 | 30.3 | 31.2 | 31.7 |
| 338.75 | 15.7 | 12.4 | 21.2 | 16.5 | 14.8 | 15.3 | 15.1 |
| 1126 | 6.2 | 4.5 | 8.1 | 5.9 | 5.9 | 5.2 | 5.804 |

The volumetric flow rate through a rectangular die used to produce a solid decking board is given by the following equation:¹
Q_{d}=W_{d} H_{d}³(ΔP_{d})/ 6ηL_{d}
where W_{d}=width of die

H_{d}=height of die

L_{d}=length of die

η=viscosity

ΔP_{d}=pressure drop across die.

Since volumetric output is inversely proportional to viscosity, i.e., Q∝1/η, the lower the viscosity with the addition of talc the higher the output for a given die pressure.

The higher the talc levels also results in higher throughput in the case of flood fed twin-screw extrusion. See Table 14c.

TABLE 14c
Increase in Output in Flood Fed Extruder

| Wt. % filler | Wt. % talc | Linear output | % increase |
|---|---|---|---|
| 59 | 0 | 14.25 | — |
| 59 | 6 | 16.375 | 15 |
| 63 | 31.5 | 19.6 | 37 |

The principles, preferred embodiments and modes of operation of the present invention have been described in the foregoing specification. The invention which is intended to be protected herein should not, however, be construed as limited to the particular forms disclosed, as these are to be regarded as illustrative rather than restrictive. Variations and changes may be made by those skilled in the art without departing from the spirit of the present invention. Accordingly, the foregoing best mode of carrying out the invention should be considered exemplary in nature and not as limiting to the scope and spirit of the invention as set forth in the appended claims.

1. A cellulosic, inorganic-filled plastic composite comprising:
a) about 20% to about 40% by weight of the composite of talc;
b) about 10% to about 60% by weight of the composite of cellulosic material;
c) about 30% to about 80% by weight of the composite of filler; and
d) about 20% to about 70% by weight of the composite of thermoplastic polymer.

2. The composite of claim 1, wherein the cellulosic material is present in an amount from about 15% to about 50% by weight of the composite.

3. (canceled)

4. The composite of claim 1, wherein the cellulosic material is present in an amount of about 33% by weight of the composite.

5. The composite of claim 1, wherein the talc is present in an amount from about 20% to about 40% by weight of the composite.

6. (canceled)

7. The composite of claim 1, wherein the talc is present in an amount of about 27% by weight of the composite.

8. The composite of claim 1, wherein the filler is present in an amount from about 40% to about 70% by weight of the composite.

9. (canceled)

10. The composite of claim 1, wherein the filler is present in an amount of about 60% of the composite.

11. The composite of claim 1, wherein the thermoplastic polymer is present in an amount from about 30% to about 55% by weight of the composite.

12. (canceled)

13. The composite of claim 1, wherein the thermoplastic polymer is present in an amount of about 40% by weight of the composite.

14. The composite of claim 1, wherein the cellulosic material is selected from the group consisting of sawdust, alfalfa, wheat pulp, wood chips, wood particles, ground wood, wood flour, wood flakes, wood veneers, wood laminates, paper, cardboard, straw, cotton, peanut shells, bagass, plant fibers, bamboo fiber, palm fibers, bast, leaves, newspaper, coconut shells, and seed fibers.

15. The composite of claim 1, wherein the cellulosic material is in the form of finely milled cellulosic fiber.

16. The composite of claim 1, wherein the cellulosic material is wood flour.

17. The composite of claim 1, wherein the talc has a purity of about 55% by weight to about 99.9% by weight.

18. The composite of claim 1, wherein the talc has a purity of 98%.

19. The composite of claim 1, wherein the thermoplastic polymer comprises a polyolefin.

20. The composite of claim 1, wherein the thermoplastic polymer comprises a polymer selected from the group consisting of high density polyethylene (HDPE), low density polyethylene (LDPE), linear low density polyethylene (LLDPE), polypropylene (PP), thermoplastic polyester, polyvinyl chloride (PVC), nylons, polystyrene, and acrylics, and combinations thereof.

21. The composite of claim 1, wherein the thermoplastic polymer is high density polyethylene.

22. The composite of claim 1, wherein the composite further comprises an additive.

23. The composite of claim 22, wherein the additive is selected from the group consisting of a lubricant, a process aid, a crosslinking agent, a coupling agent, a fungicide, a flame retardant agent, a foaming agent, a color pigment, and a blowing agent.

24. The composite of claim 23, wherein the additive is a lubricant and comprises zinc stearate and EBS wax.

25. The composite of claim 23, wherein the additive is a foaming agent.

26. The composite of claim 22, wherein said additive is less than about 10% by weight of the composite.

27. The composite of claim 22, wherein said additive is about 03% by weight of the composite.

28. The composite of claim 1, wherein the modulus of elasticity of the composite is at least about 4000 MPa.

29. (canceled)

30. The composite of claim 1, wherein the modulus of rupture of the composite is at least about 24 MPa.

31. (canceled)

32. The composite of claim 1, wherein the heat deflection temperature of the composite is at least about 106° F.

33. (canceled)

34. The composite of claim 1, wherein the creep deformation of the composite, over 24 hours under a 450 psi load at the center of 6 inch span, is at less than about 0.025 inches.

35. (canceled)

36. The composite of claim 1, wherein the weight gain of the composite due to water absorption after 1000 hours of water immersion is less than about 15% by weight.

37. (canceled)

38. The composite of claim 1, wherein the thickness swell of the composite in response to 1000 hours of water immersion is less than about 15% by weight.

39. (canceled)

40. The composite of claim 1, wherein the output of the composite from a flood fed extruder is about 15 inches per minute.

41. (canceled)

42. The composite of claim 1, wherein the composite has a hollow core.

43. The composite of claim 1, wherein the composite is foamed.

44. The composite of claim 1, wherein the composite is in the form of an article selected from the group consisting of panels, pipes, decking materials, boards, housings, sheets, poles, fencing, members, doors, shutters, awnings, shades, signs, frames, window casings, backboards, wallboards, flooring, tiles, railroad ties, forms, trays, tool handles, stalls, dispensers, staves, totes, barrels, boxes, packing materials, baskets, racks, casings, binders, dividers, walls, mats, frames, bookcases, sculptures, chairs, tables, desks, art, toys, games, wharves, piers, boats, masts, septic tanks, automotive panels, substrates, computer housings, above- and below-ground electrical casings, furniture, picnic tables, playgrounds, benches, shelters, sporting goods, bedpans, plaques, trays, hangers, servers, pools, insulation, caskets, bookcovers, canes, and crutches.

45. An article, said article comprising a cellulosic, inorganic-filled plastic composite, the composite comprising:
a) about 20% to about 40% by weight of the composite of talc;
b) about 10% to about 60% by weight of the composite of cellulosic material;
c) about 30% to about 80% by weight of the composite of filler; and
d) about 20% to about 70% by weight of the composite of thermoplastic polymer.

46-90. (canceled)

91. A method for extruding a composite, the method comprising:
a) introducing the composite into an extruder, wherein the composite comprises:
i) about 20% to about 40% by weight of the composite of talc;
ii) about 10% to about 60% by weight of the composite of cellulosic material;
iii) about 30% to about 80% by weight of the composite of filler; and
iv) about 20% to about 70% by weight of the composite of thermoplastic polymer;
b) melting the composite;
c) extruding the melted composite through a die to form an extrudate; and
d) cooling the extrudate.

92-134. (canceled)
